(19) United States
(12) Patent Application Publication
(10) Pub. No.: US 2003/0167456 A1
(43) Pub. Date: Sep. 4, 2003

(54) Architecture for building scalable object oriented web database applications

(76) Inventor: Vinay Sabharwal, Fremont, CA (US)

Correspondence Address: VINAY SABHARWAL, 43769 CAMERON HILLS DRIVE, FREMONT, CA, 94539, US

(21) Appl. No.: 09/836,681

(22) Filed: Apr. 13, 2001

Related U.S. Application Data
(60) Provisional application No. 60/198,149, filed on Apr. 17, 2000.

(51) Int. Cl. G06F 9/44

(52) U.S. Cl. 717/108

(57) ABSTRACT

A method for modeling and rapidly building high performance object oriented database applications for web environments is disclosed. The modeling encompasses behavioral object modeling as well as structural data modeling according to a set of rules that yields a layered object model with no compromises on the database design, the application's functionality or code reusability and extensibility. A high level mechanism based on the Extensible Markup Language (XML) is used to declare the structure and behavior of modeled persistent objects that exhibit functionally complete object orientation and whose implementations are realized through packages of database stored procedures and associated structures. Code generators produce the necessary application and database code from the XML specification, enabling rapid development. The packages of stored procedures encapsulate all aspects of the database design and database programming, yielding performance, flexibility and future-proofing of the applications from changing requirements, database versions and database performance tuning. The generated code, in conjunction with a lightweight run time infrastructure, provides performance and development productivity features that are specifically geared for the stateless web environment in order to support scrolling of very large result sets from the database, to automatically detect conflicting changes from multiple concurrent users, and to automatically render the state of persistent objects in XML for personalization and data interchange. Additional performance features include high-concurrency caching of persistent objects with transactional semantics for ensuring transaction isolation among multiple threads of execution.

### BACKGROUND—CROSS-REFERENCE TO RELATED APPLICATIONS

This application is entitled to the benefit of Provisional Patent Application Ser. No. 60/198149, filed Apr. 17, 2000.

### STATEMENT REGARDING FEDERALLY SPONSORED RESEARCH OR DEVELOPMENT

Not applicable.

### REFERENCE TO CD-ROM APPENDIX

The attached CD-ROM labeled WDO-Java 1.0 Beta6 contains all object code, documentation and example application programs necessary to build and run the invention using the Java programming language and the Oracle relational database management system. It corresponds to a functionally complete Beta version of a product that is based on the invention. WDO stands for Web Database Objects and is the name given to the invention.

The CD-ROM has two files:

(a) A compressed Java archive file named wdoprod10_B6.jar.

(b) A text file README1ST that contains instructions on how to install the product from the Java archive file.

Once the product has been installed, complete documentation is available in HTML format, as described in the above installation instructions.

### BACKGROUND

1. Field of Invention

This invention relates to the construction of Internet and Intranet web enabled and other database applications.

2. Description of Prior Art

Relational and object-relational database management systems are the only viable technologies today for storing, retrieving and manipulating large amounts of information. Applications that perform such operations on relational databases are increasingly enabled for access from the Internet or Intranet using web browsers. Such applications are hosted in web servers or application servers that are accessed from the web servers. The applications that run inside the web or application servers are referred to as the middle tier.

Most non-trivial applications are written in object oriented programming languages such as C++ and Java. There is an impedance mismatch between the philosophy behind object oriented programming, and relational and object-relational database programming languages that tend to be set-oriented. The most commonly used set oriented database programming language is the industry-standard Structured Query Language, referred to as SQL.

Another property of a web environment is its statelessness: each user request in a session executes in its own context, and any context sharing is required to be managed through mechanisms such as browser cookies (pieces of information that are saved in the browser and communicated with each request to the web server) or a shared database or file that is accessible from any web/application server. The challenge is to accommodate the stateless web environment without incurring performance and scalability penalties.

Finally, in order to operate on Internet time, it is necessary to build such applications very rapidly. The challenge is to be able to accomplish this objective without compromising the other objectives.

To summarize, there are three technical challenges that must be overcome when building a scalable a web database application:

1. How to resolve the impedance mismatch between object oriented technology and set oriented relational and object relational database technology.

2. How to efficiently accommodate the stateless web application environment.

3. How to build such applications rapidly.

There is also the challenge of accomplishing the above objectives cost effectively.

To date, the problem of building object oriented applications that work with relational and object-relational database systems in a web application environment has suffered from the following shortcomings:

1. Many solutions adopt the fundamentally incorrect approach of trying to map relational tables to objects. As a consequence, the solutions have the following common disadvantages:

a. Poor performance and scalability due to:

i. Excessive operations across the application/database boundary due to an improper application of the object oriented paradigm to databases that eliminates the possibility of performing the same operation much more efficiently and with less code using a database language and running inside the database.

ii. The inability to perform isolated performance tuning of database designs and database manipulation SQL statements by database experts without impacting the applications.

b. Excessive software development effort

c. Poor functionality due to an artificial force-fit of a behavioral object model to a structural data model, or worse, a force-fit of a structural data model to a behavioral object model.

2. They are based on the use of proprietary Application Programming Interfaces (API's) for database access. As a consequence, the solutions have the following disadvantages:

a. Excessive programming and software maintenance costs due to the substitution of a vendor-specific proprietary API for low level but industry standard database programming APIs and languages such as JDBC (Java Database Connectivity—a database access standard for Java programs to access relational databases) and SQL.

b. Elimination of the possibility of future-proofing the application from:

i. New capabilities that are available in future releases of the target database systems.

ii. Changes to the database design or the database manipulation SQL statements that are necessary in order to obtain satisfactory performance with large databases, as the database size grows.

3. They do not have the features and capabilities that are specifically needed for a stateless web environment. Specifically, they lack in the following areas:

a. Provision of a usable middle tier application level caching mechanism that is well integrated with the database. Some products provide generic cache managers; however, these are difficult to utilize in practice.

b. Provision of a system for efficiently retrieving very large result sets one page at a time in a stateless manner.

c. Provision of automatic mechanisms for detecting conflicting changes by multiple concurrent users operating in a stateless manner.

d. Provision of a viable mechanism for automatically synchronizing the state of the cache of multiple web/application servers in a web farm (a large number of web servers that share the user request load) for scalability.

4. The solutions conform to the premise that the implementation of all business rules belong in the middle tier, which is often referred to as the business logic layer. The consequence of this mode of thinking is poor performance coupled with a degraded user experience due to the artificial routing of processing that is better executed closest to its data coupled with the delayed response time to user error conditions.

There is also a class of solutions that enable rapid development of web database applications. However, such solutions are based on embedding database SQL inside dynamic web pages. As a consequence, web sites that are built with the approach cannot provide significant functionality, performance or scalability—they are suitable for the development of throwaway prototypes or very simple web sites.

Finally, there is another aspect of web applications that is becoming increasingly important: the rendering of database content in an Extensible Markup Language (XML) representation for web personalization and data interchange. Current solutions fail to automate this process and benefit from the caching of database objects in the middle tier.

### SUMMARY

The WDO invention consists of:

1. A high level XML vocabulary for declaratively specifying a model of the application's persistent state, behavior and relationships, referred to as its persistent component. The vocabulary also allows for embellishments to the object model to define a not-necessarily-equivalent data model and stored procedure definitions and implementations. The XML vocabulary is defined in an XML Document Type Definition (DTD) file or an equivalent XML Schema file. For a description of XML, DTD and XML Schema, please refer to the XML Standards Committee's web URL http://www.w3c.org.

2. A series of code generators that accept an application's persistent component definition expressed in WDO's XML vocabulary and produce the following code:

a. Middle tier proxy objects in C++ or Java that correspond to objects in the database.

b. Documentation for the API to the middle tier proxy objects, in a documentation language such as HTML.

c. The database interface specification for actual database-resident objects.

d. A head start set of database table definitions together with auxiliary structures such as constraints, keys, indexes and unique number generation sequences.

e. A head start implementation of the database resident objects that is based on the head start table definitions.

f. A make file that accepts the code generated C++ or Java proxy objects as input, and compiles them into a run time library that is accessed by the application.

g. A make file that installs the generated database files in a relational or object relational database system.

h. An XML vocabulary for working with instances of the persistent objects for the purpose of personalizing web content and for interchanging the data with external systems.

The key differentiator of the code generators is its use of XSL Transformation (XSLT) technology, which is a declarative XML language for converting an XML document into another XML document. The WDO code generators use XSLT to produce output that is the C++, Java, SQL etc. code described above instead of XML files. The ratio of the number of lines of output code to the input XML specification is of the order of 35 to 1 or higher. This is a rough measure of the programmer productivity that can be accomplished.

3. A run time library that provides basic services both to the code generated proxies and the application itself. The library provides facilities for managing database exceptions, transactions and collections of objects. Its key differentiator is the nature of the services it provides: these are at a very high level and represent a minimal API to the application developer. Most aspects of the run time library are used by the code generated proxy implementations themselves.

4. A methodology for modeling object oriented applications that have data persistence requirements. The key differentiator of the methodology is its use of both object and data modeling disciplines and the integration of persistent and non-persistent object models into a layered object model with well-defined rules of interaction between the layers that are described below under Operation.

### OBJECTS AND ADVANTAGES

The invention, referred to as Web Database Objects (WDO), offers the following business benefits:

1. Time to Market: Development Speed

Time to market is critical for most web projects. Equally vital is the ability to rapidly respond to changing market requirements. Developer productivity of 20 to 1 or better can be achieved with WDO relatively to hand coding a high performance and high functionality web application. For a simple application, this is on par with available rapid development tools for the web that fall short in other areas such as flexibility, extensibility, cost of ownership, project risk, and performance and scalability risks. For a sophisticated application, productivity is superior to available rapid development tools.

Incremental changes in functionality are easily accommodated with WDO, often requiring no more than a few minutes of turnaround time from the moment a change in a model is identified to the time a web site is running with the incorporated changes.

2. Time to Market: Low Project Risk

Another factor that affects time to market is the level of risk associated with a web development project. Risk factors include timely staffing of the project with personnel having the appropriate skill sets, and the level of confidence in the resulting product's performance and functionality.

Project risk is virtually eliminated using WDO. Owing to the partitioning of skill sets between Java and database developers, it is no longer necessary to hire hard-to-find developers with the multiple skill sets that would ordinarily be required for an effective implementation.

3. Low Cost of Ownership

A low cost of ownership is achieved due to the short initial and incremental development cycle and the relatively small amount of hand-written code that needs to be maintained.

Equally important, the resulting highly efficient applications consume significantly fewer hardware resources, resulting in lower operations procurement and administration costs arising from the purchase of database licenses and server hardware.

4. Future Proofing

WDO does not impose constraints on compatible upgrades to database, operating system and other run time upgrades. At the same time, a WDO database developer may readily utilize new features that may be available with database upgrades without impacting the application

5. Low Performance Risk

A recurring theme in web application development is the creeping in of unexpected and significant performance problems subsequent to initial development, when the data size or database design increases in complexity in response to changing requirements even on a moderate scale.

Although WDO provides developers with the capability of developing applications whose performance far exceeds initially anticipated requirements, the performance safety margin ensures that there are no initial surprises and that future unanticipated performance requirements (for example, as a result of adopting an Application Service Provider model) will be met.

The business benefits are realized through the following technical features:

1. Database Encapsulation

The implementation of the database objects in a stored procedure programming language completely encapsulates all aspects of the database design and data manipulation SQL commands. It is this encapsulation that is at the core of the WDO architecture, and is in contrast to the table mapping approach that is commonly adopted.

In addition to achieving skill set partitioning and high performance that are described below, database encapsulation permits application independence from the database design and the data manipulation commands, allowing the latter to change in response to changing requirements and circumstances without impacting the application.

2. Skill Set Partitioning

The problem domain is partitioned between application developers and database developers. This is a benefit because it is difficult to hire developers with the multiple skill sets that would ordinarily be required for an effective implementation. Another important benefit is the containment of the requirement for SQL database developers to a minimum and mostly isolated level.

WDO blends easily in the design, implementation and maintenance phases of an object oriented web application development project. The HTML or XML based presentation layer is completely decoupled from the database. A middle-tier object oriented application developer is not exposed to the semantics of database systems or database access. From a programming perspective, a WDO object is substantially identical to a conventional application level business object.

A database developer is not exposed to an object oriented, web, HTML, XML or any other application-programming environment. The developer performs his/her tasks based on a set of SQL package and stored procedure specifications, using the full capabilities of SQL and procedural SQL exclusively. The database developer is also free to implement the physical database design (tables, columns, object references, nested tables, primary and foreign keys and indexes) in any manner appropriate for effectively implementing the package and procedure specifications, including the use of object relational technology if desired.

3. Code Reduction

A reduction in the amount of code that needs to be hand-written is accomplished as a result of:

The high level of abstraction that is presented to the application developer, which reduces application-programming effort. Most of the code is generated and pre-debugged.

The encapsulation of SQL in stored procedures, which improves the usage of the set oriented language. A relatively small number of lines of efficient SQL code written by a database developer can replace potentially large amounts of procedural application logic.

It is possible to achieve programmer productivity of the order of 20 to 1 or better with WDO relative to hand-coding an application of equivalent quality, functionality and performance. The ratio is significantly higher if one includes the benefits of the additional transactional object caching, exception handling and transaction management functionality that is available with the run time library.

4. High Performance

Applications that are developed using the WDO methodology and product have high throughput and multi-user scalability because of the following features and capabilities:

Methodology

The WDO component modeling methodology does more than simplify the process of modeling a web database application. It provides a path of least resistance to arrive at an application architecture that respects the cost of communicating with a database system and forces the database aspects of the application to be completely encapsulated and implemented in SQL that executes inside the database.

The methodology accomplishes these results by allowing a designer to think of persistence at a coarse-grained business object level rather than at the level of database access or query languages. A systematic approach is applied to arrive at a layered object model where application level objects maintain unidirectional relationships with persistent objects. WDO's support for fine-grained persistent objects facilitates the natural modeling of containment and aggregation relationships that result in reduced communication overhead with the database. Code reuse is accomplished at the application level by using WDO's support for inheritance and polymorphism.

Stored Procedure Based Architecture

The encapsulation of all database operations inside stored procedures at a coarse business object level of granularity translates into significant performance gains relative to executing SQL using JDBC or SQLJ. In addition to reduced communication overhead, scalability is realized by leveraging Oracle's shared SQL cache which amortizes the cost of CPU and memory resources for stored procedure binary code and execution plans across multiple concurrent users.

Small Memory Footprint

A WDO application can maintain a small footprint while providing cache management and supporting collections of arbitrary size, even when working with very large databases. All cache sizes have a finite size limit and use an aging policy to maximize cache hits. Collections that are retrieved from the database are based on database result sets and are not fully materialized.

Shared Multithreaded Transactional Object Caching

Object caching can be enabled for individual classes according to the needs of the application, and the size of each cache can be independently fine-tuned. The aging policy for a cache is based on a proven least-recently-used algorithm that maximizes cache hits.

The cache management is designed to provide the maximum possible degree of concurrency among competing threads of execution: multiple readers can access a cached object concurrently with one writer. The concurrency control for cached objects is based on sound database management principles: a transparent “two phase locking protocol” is used in conjunction with transparent cache management to provide the application developer with a completely non-intrusive concurrent object access environment that is logically consistent and mirrors the environment traditionally available to database programmers: as objects are touched during a logical unit of work, they are transparently locked, and all locks are simultaneously and transparently released at the end of the logical unit of work. This eliminates the opportunity for accidentally inducing inconsistencies, deadlocks and starvation in a middle tier application.

Database Connection Pooling

The WDO run time library automatically and transparently manages a pool of self-healing database connections so that a small number of database connections can serve a large number of concurrent web users.

5. High Level XML Based Declarative Programming Language

In essence, the problem of developing an application is reduced to the problem of declaratively stating objectives in a high level XML vocabulary. It is much faster to code in a high level language than in a low level language because of the fewer lines of code that have to be written, and because the level is closer to one's way of thinking. XML is a generic mechanism for defining high-level languages.

The scope of the declarative language is currently limited to the persistent objects. As discussed under ramifications, the scope of the XML based language can be widened to encompass all aspects of an application, including the user interface and the application that uses the persistent objects.

6. High Degree and Level of Programmability

A high degree of functionality and code reuse is possible through the support of full object oriented capabilities by WDO. Specifically, the following object modeling capabilities are provided, at a business object level:

Classes with attributes, user defined methods and immutable object identifiers.

Collections.

Containment and aggregation.

Single inheritance.

Virtual methods and abstract classes.

Static and dynamic polymorphism

Fine-grained objects.

The programming paradigm that is presented to the object oriented application developer is totally devoid of database language and access concepts. In addition, an optional transaction invoker is available that eliminates the need to program for WDO exception management or WDO transaction management for implementing a logical unit of work.

7. Support for Stateless Web Environment

Scalability and user experience considerations dictate that a database connection or transaction should not span a user interaction boundary. Each user request must be fulfilled in its own single transaction. This gives rise to two problems:

How to Maintain Concurrency Control Across User Request Boundaries, Given that Locks on Database Objects Cannot Be Preserved upon Returning a Response to a User Request.

Ordinarily, the concurrency control problem is ignored, leading to perceived inconsistent behavior that has an adverse impact on user experience.

Alternatively, an optimistic concurrency control mechanism is manually coded in the application. The mechanism remembers the old state of a database object and detects a change in its state at the time of writing a new state to the database. The level of development effort involved is significant and is proportional to the number of object types.

How to Scroll Through Multiple Pages of Database Result Set Tables.

A simplistic approach that is often adopted is to materialize the entire result set in an HTML page, resulting in a sluggish response due to the run time overhead of generating the full HTML page for a single request.

Another common approach is to materialize the entire result set in memory in the middle tier upon the first request, and construct an HTML page based on a subset of the result set for each request. The drawback of this approach is reduced scalability and performance due to the large memory footprint. The problem is particularly acute for very large result sets of potentially unbounded size.

The following features are provided by WDO to simplify or eliminate application coding for the above scenarios:

Optimistic Concurrency Control

At the object model level, it is sufficient to tag object attributes as interesting for the purposes of change detection. WDO automatically and efficiently manages the details of implementing optimistic concurrency control through detection of changes to the specified attributes.

Stateless Scrollable Cursors

WDO allows the object modeler to define list retrieval methods that manage list context. The associated design pattern permits a simple and efficient implementation in the database. This permits a web application to efficiently scroll through a potentially infinite sized list page by page such that successive page requests can be routed to different servers in a web farm for reasons of fault tolerance and load balancing.

8. Support for Web Personalization and Enterprise Data Interchange

The application developer is relieved of the responsibility of writing code to render database object state in XML for web personalization and data interchange. All stateful WDO objects and their collections have available an implicit method to render their state in XML according to a code generated XML document type definition.

### DRAWING FIGURES

FIG. 1 illustrates the architecture of traditional object relational mapping systems that the WDO architecture is intended to replace. It shows how the structures and relationships of database tables are surfaced to an application developer, and the high level of communication that occurs between the application and database for accessing and manipulating the tables.

FIG. 2 illustrates the core WDO architecture. It shows how a component that appears as a set of functionally complete business level C++ or Java objects to an application actually maps to an equivalent set of stored procedures and structures in the database and how the proxies internally communicate with the database server over the network or interprocess communication boundary.

FIG. 3 illustrates the WDO modeling methodology. The processes of performing structural data modeling and behavioral object modeling are illustrated.

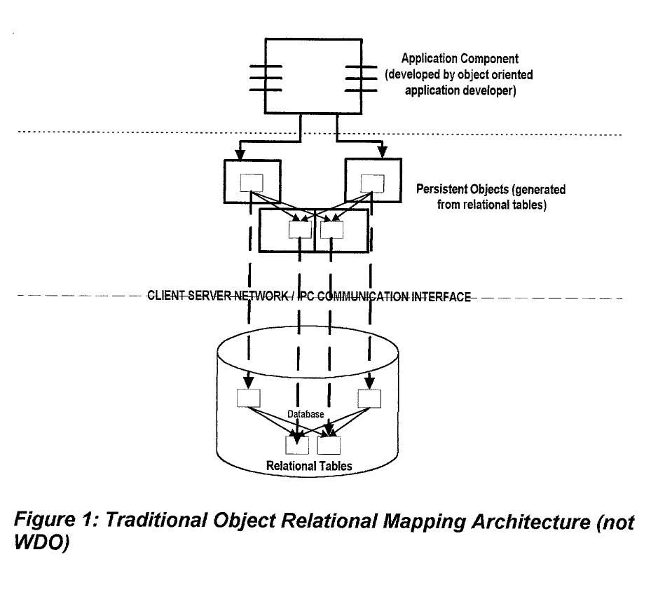

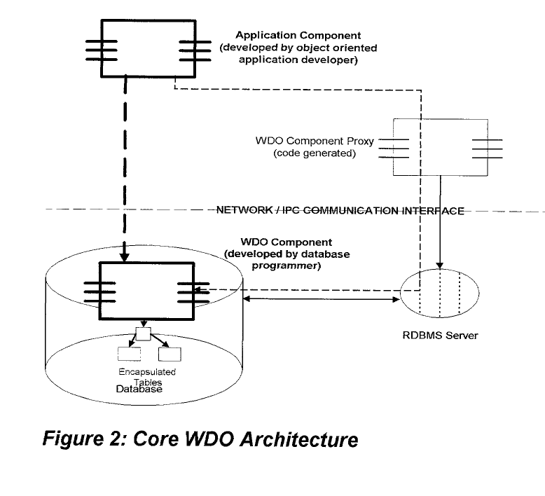

An example of a layered object model that is arrived at using the WDO modeling methodology is illustrated in FIG. 4, which represents a trivial order entry application. The notation used in the object model is industry-standard UML (Universal Modeling Language). The figure shows how application level objects add value to persistent objects and reuse the persistent objects by inheriting from them and adding attributes and behavior that pertain to the middle tier. Also shown is the use of lightweight second-class objects that are managed by first class, or functionally complete, container objects. The first class persistent objects are shown with business-rule-level behavior.

FIG. 5 illustrates the data model that corresponds to the example application illustrated in FIG. 4. The notation that is used is a widely used IEF (Information Engineering) notation also referred to as Crow's Feet. The data model illustrates how internal database structures are decoupled from what the application needs to see at a semantic level. In this case, certain internal primary key and foreign key columns are not visible at the object model level.

The application lifecycle using the WDO methodology and architecture is shown in FIG. 6. The flowchart shows the sequence of modeling, component definition, code generation and customization steps, and the iterations that occur whenever there is a change in requirements.

FIG. 7 shows the run time environment of an application that uses persistent components based on WDO. The interactions between the application objects and the code generated proxies and run time infrastructure elements are illustrated. Also shown is the internal interaction between the components of the run time library and the code generated persistent object proxies.

### DESCRIPTION

As described in the Summary, the key components of the invention are the modeling methodology, the XML vocabulary, the code generators and the run time library.

Modeling Methodology

An object-oriented analyst and a database designer use the WDO modeling methodology to develop the behavioral and structural models for a given component respectively and arrive at an integrated object model. It is summarized below:

The analyst develops a behavioral object model of the web application component based on a use case analysis.

Concurrently, the database designer develops an entity-relationship diagram of the data whose persistent state is required to be maintained in the database system.

From the entity-relationship model, the database designer derives a preliminary persistent component object model. At this point, the model has classes with attributes and relationships but no useful methods.

The models are reconciled into a layered object model according to the following guidelines:

(a) Behaviors that pertain to persistent objects are associated with the persistent objects themselves.

(b) The persistent objects are organized into full-featured first class objects and simple fine-grained second-class objects that have attributes and no behavior.

(c) The interaction between the objects in the two layers is designed according to a set of modeling rules that are explained below.

The outcome of the analysis and design phase is a persistent component model that matches the needs of the application model, has domain-level behavior, is decoupled from the physical database design and is optimally designed for performance and scalability.

The following rules guide the process of reconciling the behavioral and initial persistent object model into a layered and integrated model as a path of least resistance towards a realizable and efficient application architecture.

| RULE | REASON | REMARKS |
|---|---|---|
| Rule #1: A class defined in a | Maintain unidirectional | This rule can be relaxed |
| WDO component cannot have a | dependency between non-WDO | somewhat when database stored |
| has-a (containment), uses or is-a | and WDO classes. | procedures that are implemented |
| (inheritance) relationship with a | | in an object oriented |
| non-WDO class. | | programming language such as |
| | | Java are used to interact with |
| | | external systems for low- |
| | | bandwidth operations. |
| Rule #2: A WDO class can have | Inheritance is supported. | |
| an is-a (inheritance) relationship | | |
| with a WDO class. | | |
| Rule #3: A non-WDO class can | The memory management of a | The capability is useful in a |
| inherit from a first or second | first class is completely handled | layered object model. For |
| class. If the former, its | by its static member factory | example, an order entry |
| instantiation is possible only | methods. It cannot be | application's line item class |
| with a first class factory method. | relinquished to a derived non- | may extend the attributes of |
| A WDO class cannot inherit | WDO class having additional | an line item WDO class with |
| from such a non-WDO class due | attributes | attributes, methods and |
| to Rule #1. | | relationships that are relevant |
| | | only to the run time |
| | | environment. |
| | | An application object that |
| | | inherits from a first class can |
| | | be cached and locked just like |
| | | a first class. It may also |
| | | provide client-side |
| | | implementations for abstract |
| | | first class methods. |
| Rule #4: A second class cannot | A second class is not much more | A second class can be a base |
| have useful methods or | than a DBMS-resident structured | class for a first class declared |
| constructors defined on it. | data type. | within the same WDO |
| | | component, but the reverse is |
| | | not true. |
| | | The DBMS implementation of |
| | | the WDO classes can map |
| | | both variants of a class to the |
| | | same instance of the same |
| | | underlying database structure |
| | | (for example, a row of a table) |
| | | if required. |
| Rule #5: A first class cannot | | Also, see the reason for Rule #3. |
| have constructors defined on it — | | |
| at least one set of static member | | |
| methods is implicitly provided | | |
| for instantiating an instance of | | |
| the class. | | |
| Rule #6: A first class can have | | As expected, an abstract WDO |
| virtual methods defined on it. A | | class cannot be instantiated. |
| virtual method may be an | | However, it does have available |
| abstract method. | | the default static member |
| | | methods for instantiation of |
| | | application level derived classes. |
| Rule #7: A non-WDO class can | | |
| have a uses or is-a relationship | | |
| with a WDO first or second- | | |
| class. | | |
| Rule #8: A WDO class may | The restriction on classes that are | |
| contain another class. The | allowed to be contained preserves | |
| contained class must be a WDO | the unidirectional dependency | |
| class or a base Java class. | relationship between the | |
| | application and persistent object | |
| | layers, and also simplifies the | |
| | implementation. | |

WDO XML Vocabulary

The WDO vocabulary is expressed in a meta-language such as XML Schema or Document Type Definition. It specifies the arrangement of elements and attributes that constitute the vocabulary for defining the entities and attributes that constitute a persistent object model.

A reference implementation of the XML vocabulary is available in the file wdo.dtd in the appendix CD ROM (after unpacking and installation) for the specific context of a Java programming language and an Oracle relational database management system.

Each WDO component is represented in a separate XML file whose underlying schema is defined in the WDO Document Type Definition file that is part of WDO. Although the XML file may be created and edited using any text editor, it is best composed using a validating XML editor such as XML Spy in order to avert XML syntax errors and ensure a valid and well-formed document.

The concepts that are represented include both object and database concepts. In most instances, there is a correspondence between the two; however, it is also possible to represent concepts that pertain solely to the Java application environment, the database stored procedure environment, and the logical or physical database design level. Accordingly, the process of defining the XML representation requires the involvement of both the Java developer and the database developer.

Each major WDO concept is represented as an XML element. Related concepts may be represented as either XML elements or XML attributes.

The XML file for a persistent component consists of a single component element, which contains the definitions of all persistent classes and their supporting definitions. A component can also contain external references to entities that are defined in a different XML file. That is, automatic code generation can be performed for inter-component references (for example, database foreign keys across component boundaries, or Java package imports).

A persistent class element contains elements that define its attributes, methods and relationships. A method class element contains argument elements and return value attributes that define its signature.

Supporting definitions that are used by the class definitions include encapsulated base data type definitions and mappings between Java and the database, referred to as domains. Constant and enumeration type definitions may also be specified for each class for use by the Java application developer.

All elements contain comment elements for the purpose of embedding comments into the generated code. Additionally, pass-through elements are available to embed Java, database definition and database SQL code directly into the XML file for arbitrary extensibility.

At its most basic level, the XML definition for a component is generic and applies to both Java and database developers. Several optional elements and attributes exist that allow for fine-tuning the generation of the Java and database code.

Generated Code

The following description of the generated code is based on a specific implementation for Java and the Oracle relational database management system on a UNIX operating system. Equivalents can be similarly defined for other programming languages, database management systems and operating system platforms.

The component name influences the names of the directories and files that are generated by running the code generator. These are deposited in subdirectories of the target directory that is specified in the arguments to the code generator. The names of the subdirectories are derived from the component name according to their function, as follows (bold italicized strings target and component represent placeholders for the target directory (for example “.”) and component name (for example “userinfo”) respectively, and bold strings are literal values, for example _sql. For example, target/component_sql can be ./userinfo_sql):

target/component:

A class.java file for each first and second class defined in the component and not specified as an imported class or a class for which Java proxy code generation is turned off. For example, if the userinfo component has User and Address classes defined, two files User.java and Address.java are deposited in this directory. The files are generated in read-only mode as they are not intended to be modifiable or even viewable—all pertinent interface information is contained in the HTML-format Java documentation that is generated and described below. The Java files are used to produce the component.jar file that is included in the application's class path for compilation and execution, as described below.

An operating system specific makecomponent command file. Execution of the command file on the appropriate operating system platform results in the creation of a component.jar file in the target directory. If a package prefix is specified, the component directory is verified to be located at the appropriate target directory.

The contents of the directory are pertinent only to a Java developer. As discussed above, the relevance is only in the context of an application build environment.

By default, the Java code generation process automatically builds the target jar file and cleans out the java source files.

target/component_sql:

A component.sql file that contains Oracle PL/SQL stored procedure package interface definitions for the component, one per class that is not specified as an imported class or a class for which PL/SQL code generation is turned off. The interface file is generated in read-only mode as it is not intended to be modifiable.

A componenttbl.sql file that contains head start Oracle table, constraint, index and sequence definitions, one per stateful class that is not specified to have table generation turned off. The file may optionally be customized by the database developer as appropriate.

A componentimp.sql file that contains head start Oracle PL/SQL stored procedure package implementation code, one per class that is not specified to have PL/SQL code generation turned off. The file may optionally be customized by the database developer as appropriate.

A makedbcomponent command file that executes componenttbl.sql, component.sql and componentimp.sql using Oracle's SQL*Plus command line utility against a specified target database instance and schema. The command works on any operating system platform on which a Korn shell is available.

The SQL files are automatically executed against the database by makedbcomponent in the proper sequence as a complete head started database component installation. They may also be executed in isolation with Oracle's SQL*Plus command line utility.

The contents of the directory are pertinent only to a database developer.

target/component_doc:

The directory contains HTML documentation for the component. Its content and structure are determined by the javadoc utility. A java application developer uses the component documentation by opening the index.html file in this directory in a web browser. The documentation is intended to be the exclusive interface specification that should be available to the Java developer. That is, it should not be necessary for the developer to browse through the generated Java source code.

The documentation includes generic and Java specific comments that are provided in the XML component definition, as well as additional comments that are code generated for implicit methods. Private internal methods that are technically public for implementation reasons are flagged as such.

The Java documentation is not of significant interest to a database developer, who sees the comments directly in the head start database implementation code if it is to be customized.

target/component_xml:

A single XML Document Type Definition (DTD) file is generated. It defines the format of the XML that is rendered for all stateful classes of the component through an implicit toXML( ) member method that is code generated for each such class. The XML rendering is specified in detail in the document that is included in the CD-ROM attachment. It is important to note that there is no correlation between the component-specific XML rendering and the WDO XML component specification; the latter defines a component at application development time, whereas the former defines the states of specific instances of the class at application run time.

Code Generators

The code generators are a series of XSL transformation files that are driven by a Perl or shell command file, possibly from a graphical user interface. The files in the CD-ROM attachment contain the source code for one specific instance of a code generator implementation consisting of a Korn Shell command file and the associated XSL transformation files.

Run Time Library

The run time library is used primarily by the generated code. It is also utilized to a limited degree by an application that uses a persistent component that is built using WDO.

The application developer imports the run time library and then optionally uses the following classes that constitute its API:

Transaction Class

The purpose of the transaction class is to simplify management of logical units of work in a multithreaded application.

At its simplest level, an application can implicitly use a transaction object without being aware of the concept if unit-of-work functionality is not important.

If unit-of-work functionality is required, the application can explicitly manage its unit of work by creating a transaction object, performing multiple operations without explicitly tracking the transaction context, and at the end of the day locating the transaction object and instructing it to either commit or roll back the transaction.

An application can also accomplish unit-of-work functionality without explicitly writing code for transaction or exception management. The set of operations that are to be atomic are organized into a class that implements the unit-of-work interface (described below) and registered with the transaction class.

A transaction object transparently tracks all first class objects that participate in the logical unit of work, and synchronizes their state with transaction events such as commit and rollback.

Unit-of-Work Interface

The interface is a simple protocol that an application can optionally implement to accomplish unit-of-work functionality without coding for it, as described above. Implementing the interface consists of adhering to a signature for the method that defines the unit of work and a generic way of marshalling and unmarshalling arguments.

Base WDO First Class Interface

The interface is a simple protocol that all WDO first class objects implement. It is useful for safely typecasting first class objects.

Iterator Class

The iterator class is the mechanism by which the application receives and processes a collection of WDO objects. It provides methods to check for more results and to obtain the next result.

An application may use the standard Java Vector instead of the iterator for small collections.

Exception Classes

The exception classes are intended to be used to catch and act upon WDO exceptions, for example to retry an operation that failed due to a temporary error condition. They are organized into a hierarchy of specific exceptions that subclass a base WDO exception.

Argument Container Class

The argument container class is used to receive output parameters from a method invocation when it is infeasible to communicate the values through function return values because multiple values are to be returned and when the programming language does not support this concept (for example Java).

Operation

The application development lifecycle is illustrated in FIG. 6.

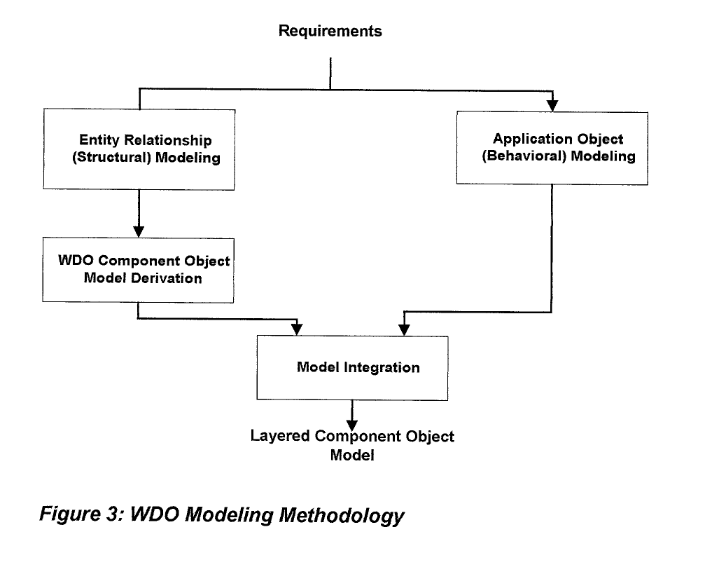

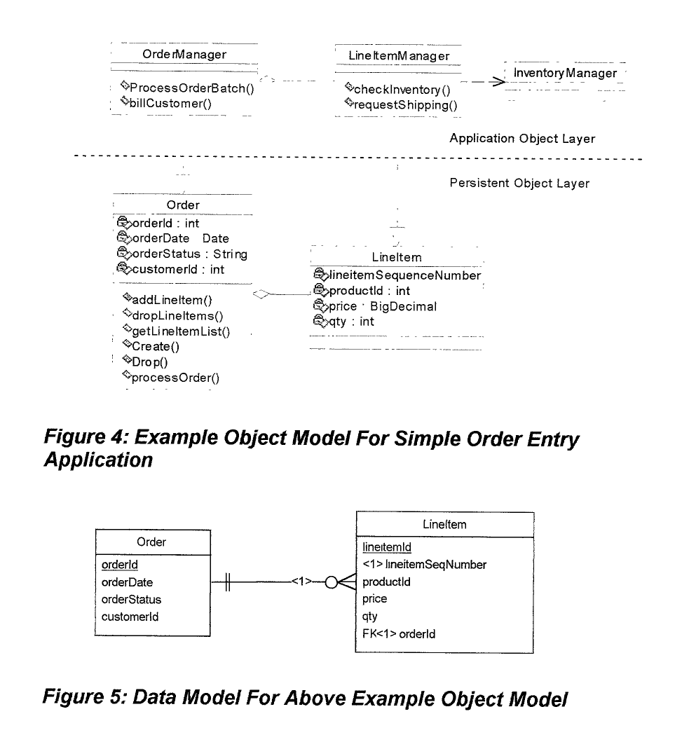

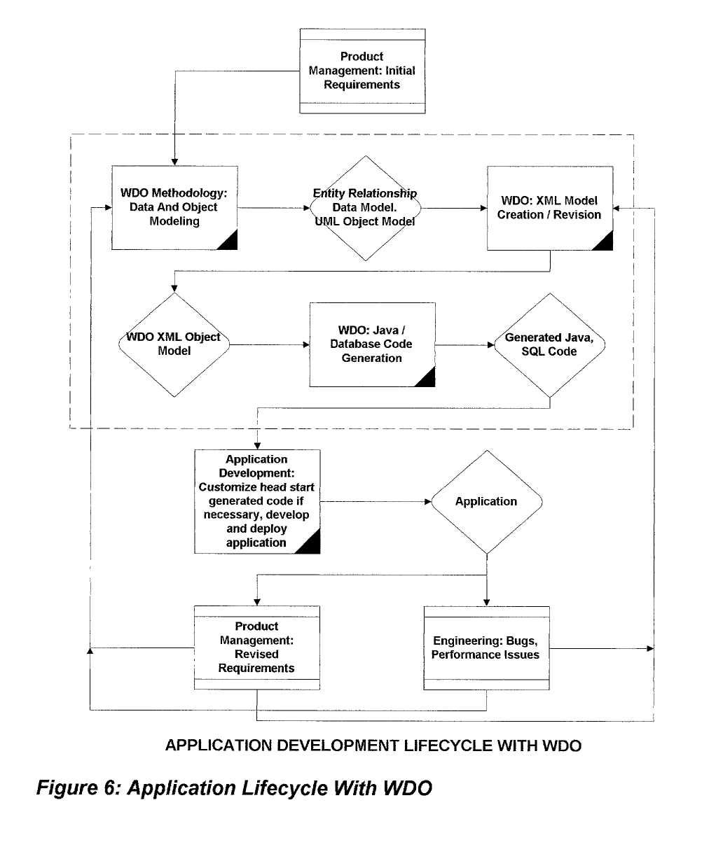

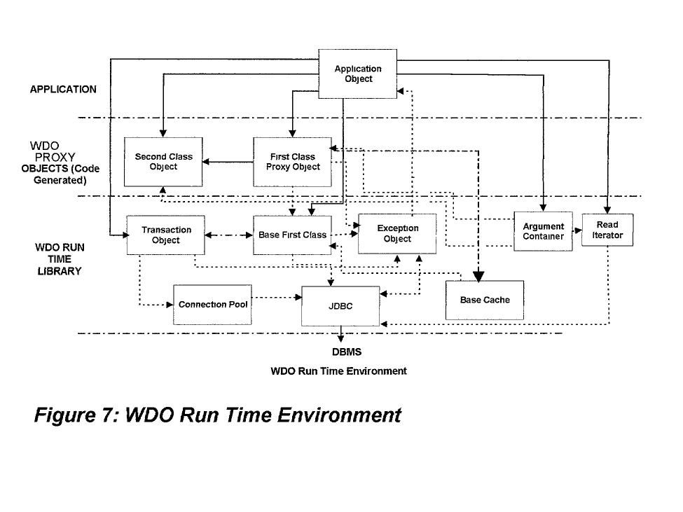

First, the WDO modeling methodology is applied to capture the application requirements in a layered object and data model, as illustrated in FIG. 3.

Next, the persistent object model in the lower layer of the layered model is represented in an XML file using the WDO XML vocabulary, and is embellished to add data model and other information so as to arrive at a self-contained definition from which all application and database code can be generated. This is accomplished using either a text editor or an XML editor.

The code generators are then executed against the XML file, either individually or in a single command. In the extreme scenario, the output of the code generation process is a fully deployed persistent object library binary file and an installation of the persistent component's database procedures and tables in a database system.

An application developer then utilizes the API's of the persistent component to develop an application that may include objects that have a relationship with the objects in the persistent component. Depending on the application's needs, the application developer also minimally uses the WDO run time library in order to coordinate exceptions and transactions, and process collections of objects.

A database developer optionally customizes the code generated database table definitions and stored procedure implementations to add functionality for user-defined methods or to customize head start designs. The customization may also be performed for the purposes of database performance tuning.

As part of application deployment, the persistent component run time libraries and the WDO run time library are placed in a path where the application can access them, and the database files are installed in the target database. A set of operating system environment variables are defined, or a property file is created, that specify the database connection authorization information and other system tuning parameters such as retry counts.

When the application is executed either standalone or from a web/application server, it accesses the persistent components' classes and optionally the WDO run time library classes, as illustrated in FIG. 7. These classes in turn transparently perform the necessary database operations as necessary using lower level database APIs that are not visible to the application. The classes also manage optimizations for minimizing database communication by caching objects and deferring database accesses wherever possible. In addition, they internalize all housekeeping that pertains to managing context in a programming environment where multiple operating system threads execute concurrently in the same process address space. All aspects of operating within the context of a transaction and allocating and deallocating database resources such as connections, statement contexts and cursors are also internalized. In effect, the application is operating within a framework rather than invoking a large number of proprietary API's.

All communication to the database consists of execution of database stored procedures. That is, no data manipulation SQL is ever executed from the middle tier. The implementations of the database stored procedures consist of SQL and procedural SQL code that actually operate on the database tables, both to access and manipulate data and to implement data-intensive business rules directly inside the database in a compact and efficient manner.

Conclusion, Ramifications, and Scope

It is apparent from the above description that a high performance and high functionality web-enabled database application can be developed very rapidly and with minimal developer resources. The resulting application is future-proofed with respect to changing requirements, new database versions and new requirements for data personalization and interchange due to the database encapsulation and built-in support for rendering XML state.

The ideas presented here are equally applicable to the development of any online transaction processing application in a multitiered environment, even if it is not web enabled.

So far, we have covered the automation of the middle tier and back end aspects of a multitier database application, which represents the most significant aspect of a complete database intensive application. The approach can be extended to automating the construction of an entire web site including the user interface. We can do this by adopting and automating the Model/View/Controller (MVC) architecture described in “Design Patterns: Elements Of Reusable Object Oriented Software”—Gamma, Helm, Johnson, Vlissides, Addison-Wesley, 1995. In this architecture, the Model is the application object, the View is its screen presentation, and the Controller defines the way the user interface responds to user input. In the context of a web site, the View corresponds to the HTML screens. The Controller determines the coupling between the model and multiple views.

We have automated the Model as described above. We can apply a similar approach to automate the Controller and View in order to achieve the automation of a complete no-compromise web site.

I claim:

1. A method for effectively modeling a scalable web database application for online transaction processing that uses an object oriented programming language and a relational or object-relational database system, such that:
a. neither functionality nor performance is compromised.
b. all persistence related entities are isolated into a well defined layer that encapsulates database designs and operations on database tables.
c. persistent objects are functionally complete objects complete with behavior, inheritance, polymorphism and containment over and above basic object oriented features such as state and identity.
d. There is a partitioning of skill sets between database developers and object oriented application developers.
by utilizing both object modeling and data modeling techniques and applying a set of rules for arriving at a layered object model where the objects in the layers interact according to well defined rules set forth in this patent application.

2. A run time architecture for effectively managing database operations from an object oriented application that is based on a proxy design pattern as defined in the book Design Patterns: Elements Of Reusable Object-Oriented Software by Erich Gamma, Richard Helm, Ralph Johnson and John Vlissides published by Addison Wesley, 1995, ISBN 0-201-63361-2. In particular, the proxy objects have methods, virtual functions, abstract classes and polymorphism, and provide optimizations for minimizing database communication. They are also cached in memory with transactional semantics. The key difference from prior applications of the proxy design pattern is in the application of the proxy to database resident objects.

3. A technique for using the Extensible Markup Language (XML) to define high level programming languages for building complex systems, by defining a corresponding XML vocabulary using an XML Schema or a Document Type Definition and using XSL Transformation software to produce code that implements the systems.

4. An XML vocabulary for defining database-persistent components and their classes, attributes, methods, relationships and various physical parameters such as database storage placement and control parameters, as well as parameters that control their behavior in the middle tier, such as caching and synchronization.

5. A technique for using XSL Transformation software to realize an XML based high level programming language by generating the code in existing lower level programming languages to implement the necessary functionality.

6. Techniques for using XSL Transformation software to generate, from the XML high level programming language, database table definitions and related database structures such as indexes, unique number generators and constraints.

7. Techniques for using XSL Transformation software to generate, from the XML high level programming language, database stored procedure and associated definitions such as records and packages to implement objects having state, behavior and relationships such as inheritance and containment.

8. Techniques for using XSL Transformation software to generate, from the XML high level programming language, middle tier object oriented code.

9. Techniques for using XSL Transformation software to generate, from the XML high level programming language, XML Schemas and Document Type Definitions that represent the structure of the XML that is rendered at run time from the actual state of the objects that are defined in the high level XML language.
